(19) United States
(12) Patent Application Publication
(10) Pub. No.: US 2011/0059634 A1
(43) Pub. Date: Mar. 10, 2011

(54) ELECTRCIAL CONNECTOR WITH ABUTTING RIBS AGAINST PCB

(75) Inventor: DE-JIN CHEN, Shenzhen (CN)

(73) Assignee: HON HAI PRECISION INDUSTRY CO., LTD., Tu-Cheng (TW)

(21) Appl. No.: 12/875,681

(22) Filed: Sep. 3, 2010

(30) Foreign Application Priority Data
Sep. 4, 2009 (CN) 200920309647.7

(51) Int. Cl. H01R 12/14; H01R 24/00

(52) U.S. Cl. 439/83; 439/660; 439/55

(57) ABSTRACT

An electrical connector includes a plurality of terminals with tail portions and an insulating housing defining a mounting face and a mating face opposite to the mounting face. The insulating housing includes a plurality of parallel first walls extending in a first direction and a plurality of parallel second walls extending in a second direction perpendicular to the first direction and unitarily intersecting with the first walls to construe a plurality of passageway to receive the terminals. The tail portions of the terminals extend beyond two outermost first walls in the second direction. A pair of first ribs extends from one second wall away from the mounting face and the ribs do not exceed the outermost first walls in the second direction.

### BACKGROUND OF THE INVENTION

1. Field of the Invention

The present invention generally relates to an electrical connector which is mounted on a printed circuit board.

2. Description of the Prior Art

U.S. Pat. No. 5,961,339 discloses an electrical connector mounted on a PCB. The connector defines a pair of guiding posts on a mounting face thereof and the PCB defines a pair of guiding holes. The connector can be put to a predetermined position through the guiding of the posts and the holes. Sometimes, the position process might be cost a long time since the posts and holes are small in dimension. A better assembly efficiency of the connector to the PCB is needed.

Hence, an improved electrical connector is desired to overcome the disadvantages of the prior art.

### BRIEF SUMMARY OF THE INVENTION

Therefore, an object of the present invention is to provide an electrical connector having a position spacer which has guiding means to the terminals.

To fulfill the above-mentioned object, an electrical connector comprises a plurality of terminals comprising tail portions and an insulating housing defining a mounting face and a mating face opposite to the mounting face. The insulating housing comprises a plurality of parallel first walls extending in a first direction and a plurality of parallel second walls extending in a second direction perpendicular to the first direction and unitarily intersecting with the first walls to construe a plurality of passageway to receive the terminals. The tail portions of the terminals extend beyond two outermost first walls in the second direction. At least one first rib extends from one second wall away from the mounting face and the at least one rib do not exceed the outermost first walls in the second direction.

Other objects, advantages and novel features of the invention will become more apparent from the following detailed description when taken in conjunction with the accompanying drawings.

### BRIEF DESCRIPTION OF THE DRAWINGS

The foregoing summary, as well as the following detailed description of the embodiments of the present invention, will be better understood when read in conjunction with the appended drawings. For the purpose of illustrating the invention, there are shown in the drawings embodiments which are presently preferred. As should be understood, however, the invention is not limited to the precise arrangements and instrumentalities shown. In the drawings:

FIG. 1 is a top assembled perspective view of an electrical connector assembly made in accordance with the present invention;

FIG. 2 is a bottom assembled perspective view of the electrical connector assembly;

FIG. 3 is an exploded perspective view of the electrical connector assembly from a bottom view;

FIG. 4 is a perspective view of the terminal;

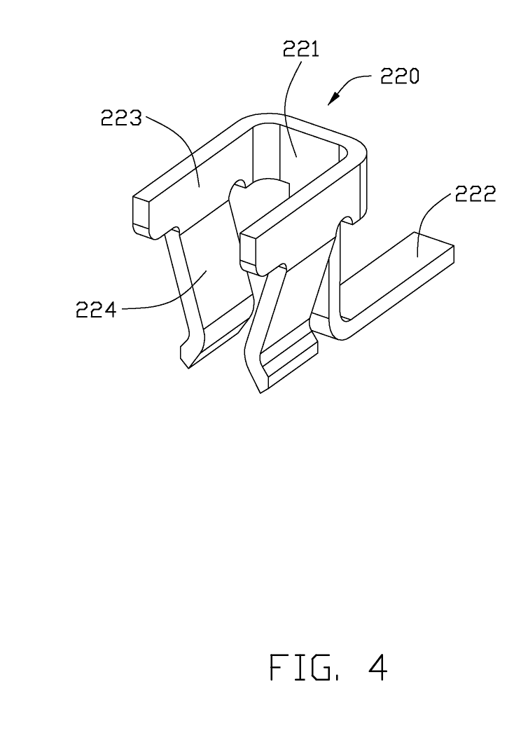

FIG. 5 is a cross sectional view of the electrical connector assembly taken along line 5-5 in FIG. 1; and

FIG. 6 is a cross sectional view of the electrical connector assembly taken along line 6-6 in FIG. 1.

### DETAILED DESCRIPTION OF THE PREFERRED EMBODIMENT

Reference will now be made in detail to the preferred embodiment of the present invention.

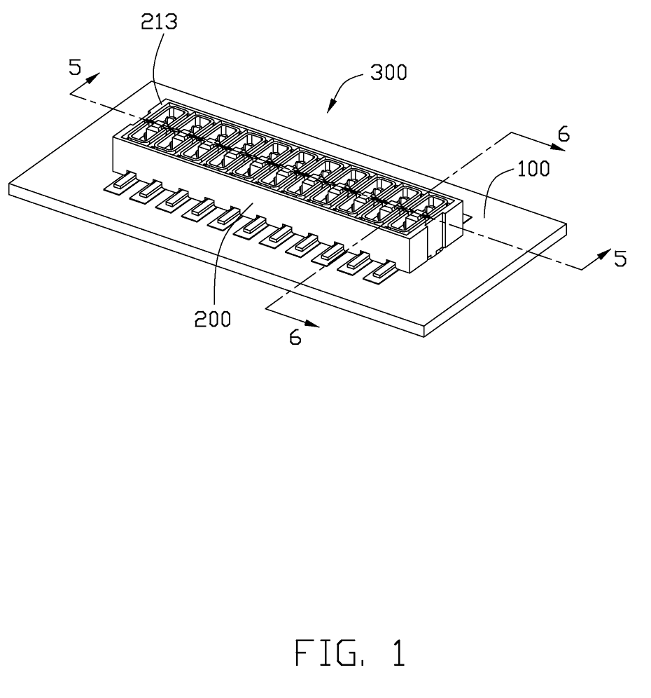

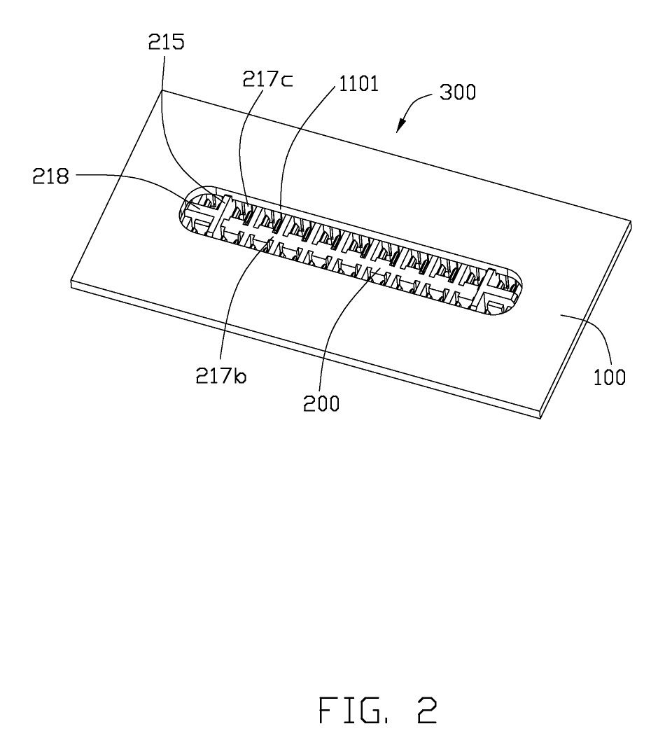

With reference to FIGS. 1-2, an electrical connector assembly 300 in accordance with the present invention is provided, which include a printed circuit board 100 (PCB) and an electrical connector 200.

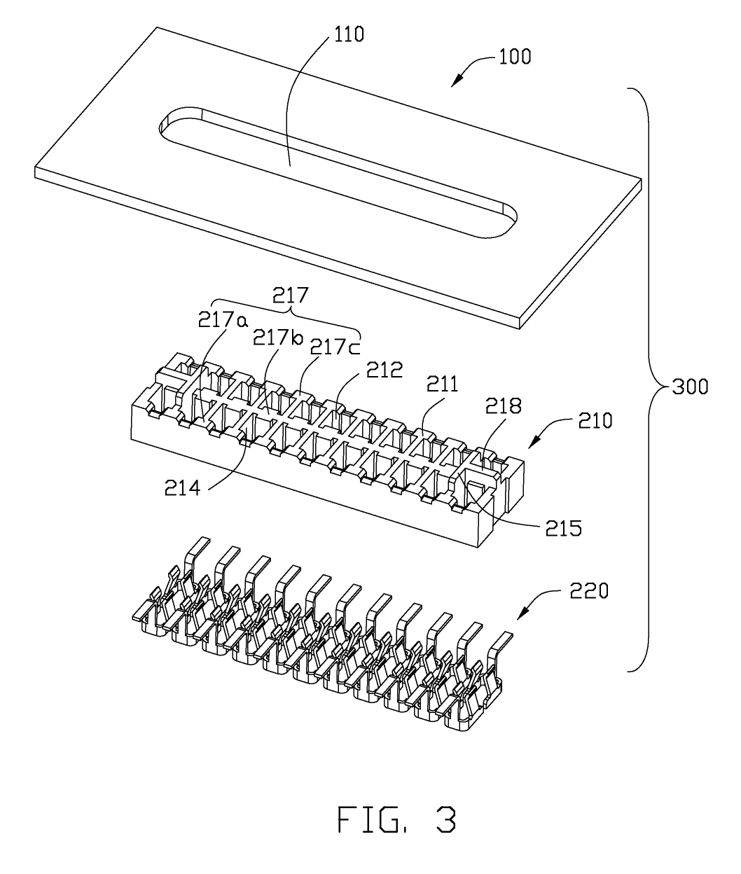

Referring to FIG. 3 the electrical connector 200 includes an insulating housing 210 and two rows of terminals 220. The insulating housing 210 defines a mounting face 211, a mating face 213 (labeled in FIG. 1) opposite to the mounting face 211 and a plurality of passageways 212 through said two faces. The passageways 212 are construed with a matrix pattern, in a preferred embodiment the passageways 212 are arranged in two rows and each row extend in a first direction. The insulating housing has three parallel long walls 217 or first walls extending in the first direction and a plurality of parallel short walls 214 or second walls perpendicular to and unitarily intersecting with the long walls 217 in a second direction, thereby each passageway is construed.

Referring to FIGS. 2 and 3, each terminal 220 includes a U-shaped base portion which includes a middle arm 221 and two parallel side arms 223 at two sides of the middle arm, a tail portion 222 extending downward from the middle arm of the base portion and a pair of elastic portions 224 in the shape cantilever arm extending downward from the side arms 223. The terminals are inserted in the passageways 212 from the mounted face 211. The tail portions extend perpendicularly beyond the two outermost long walls 27a, 27c. The pairs of elastic portions 224 contained in the passageways, are arranged along the first direction. The elastic portions of each pair more slantwise toward each other more to the mounting face 211.

Please referring to FIG. 3, two first ribs 215 unitarily extend downward from the two short walls 21s which are the second one of the short walls near to two distal ends of the rows, and far away from the mounting face 211. The first ribs do not exceed the two outermost long walls 217 in the second direction. Two second ribs 218 unitarily extend downward from the middle long wall 27b beyond the mounting face 211 and intersect with the corresponding first ribs. The second ribs are aligned with the distal ends of the rows. The first and the second ribs have a same height and are formed in a T shape.

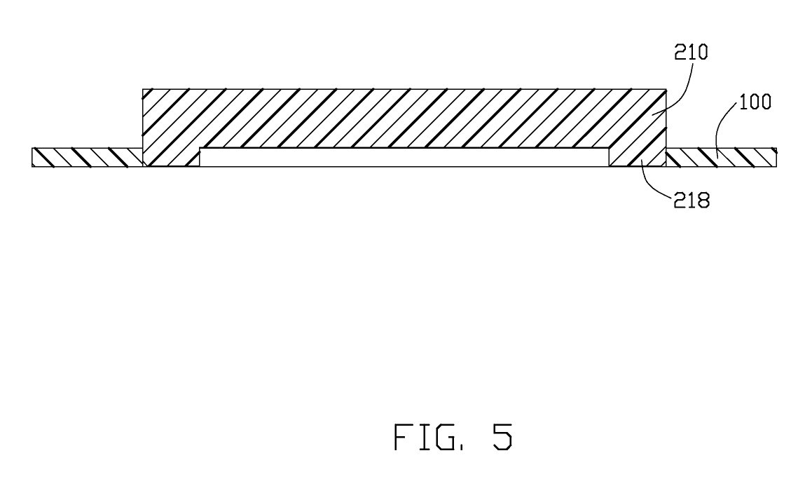

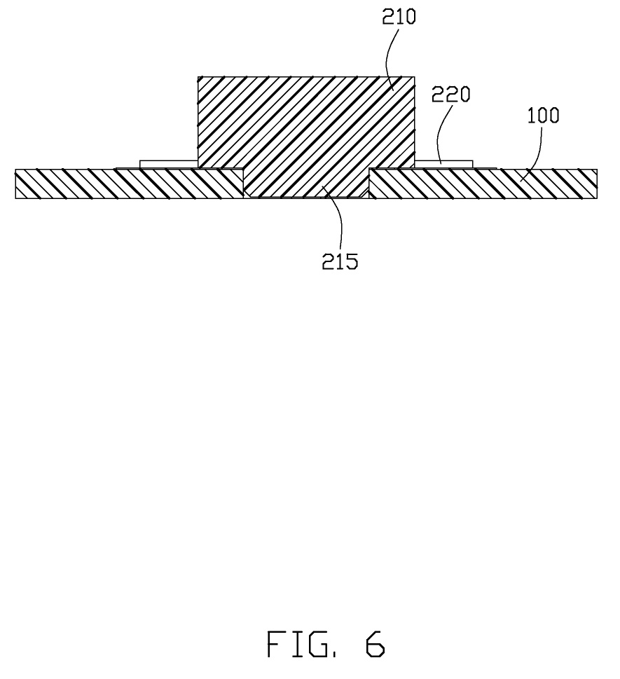

The PCB defines a long open 110 extending in the first direction. The first and second ribs 215,218 can guide the connector to the long open 110 observing though the long open. Seeing FIGS. 1 and 2, the connector is seat on the PCB by the outermost long wall 217a, 217c on one surface of the PCB. Combination with FIGS. 5 and 6, the first ribs 215 abut against the longer inside edges 101 of the long open and the second ribs 218 abut against the short inside edges of the long open. The first ribs 215 also limit the connector to avoid shifting in the second direction and the second ribs 218 limit the connector to avoid shifting in the first direction. The tail portions 222 are soldered to conductive pads on the PCB to retain the connector on the PCB and complete electrical connection. Moreover, the ribs interfere with the side of the long open to further retain the connector on the PCB.

Alternatively, if an electrical connector has only two long wall, the first ribs can disposed the short wall but do not exceed the long walls in the second direction, as a result that the long wall can provide a mounting face to confront with the PCB, and the second ribs is omitted. If an electrical connector has more than three long walls, the first ribs and the second ribs can be disposed in multi-patterns. If the ribs are too long, the rib can be interrupted.

It is to be understood, however, that even though numerous, characteristics and advantages of the present invention have been set fourth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
a plurality of terminals comprising tail portions;
an insulating housing defining a mounting face and a mating face opposite to the mounting face, the insulating housing comprising a plurality of parallel first walls extending in a first direction and a plurality of parallel second walls extending in a second direction perpendicular to the first direction and unitarily intersecting with the first walls to construe a plurality of passageway to receive the terminals, the tail portions of the terminals extending beyond two outermost first walls in the second direction;
wherein at least one first rib extends from one second wall away from the mounting face and the at least one rib do not exceed the outermost first walls in the second direction.

2. The electrical connector as claimed in claim 1, wherein at least one second rib extend from a middle one of the first walls away from the mounting face and the at least one second rib joins with the at least one rib.

3. The electrical connector as claimed in claim 2, wherein each of the terminals comprises a base portion retained in the passageway adjacent to the mating face of the insulating housing and a pair of elastic portions adjacent to the mounting face.

4. The electrical connector as claimed in claim 3, wherein the tail portions extend from the base portion.

5. An electrical connector assembly comprising:
a printed circuit board defining therein an opening with opposite first sides;
an electrical connector mounted in the opening of the printed circuit board, the electrical connector comprising:
an insulating housing defining a mounting face confronting with one surface of the printed circuit and at least one first rib unitarily extending from the mounting face and abutting against said opposite first sides of the opening of the printed circuit board;
a plurality of terminals comprising tail portions connecting with said one surface of printed circuit board at the first sides of opening.

6. The electrical connector as claimed in claim 5, wherein the first sides are longer than other sides.

7. The electrical connector as claimed in claim 6, wherein the insulating housing defines at least one second rib abutting against said other sides.

8. The electrical connector as claimed in claim 7, wherein the at least one first rib joins with the at least one second rib perpendicularly.

9. An electrical connector assembly comprising:
an insulative housing defining a mating port extending in a longitudinal direction and a lateral direction perpendicular to each other, and having thereon a mating face facing toward a vertical direction perpendicular to both said longitudinal direction and said lateral direction;
a plurality of passageways formed in the housing, each of said passageways defining an opening in the mating face to communicate the passageways with an exterior in said vertical direction;
a plurality of contacts disposed in the corresponding passageways, respectively, each of said passageways being configured to allow corresponding contact to be assembled thereinto only along another vertical direction opposite to said vertical direction via the corresponding opening; wherein
each of said contacts defines a solder tail horizontally outwardly extending around the mating face in said lateral direction.

10. The electrical connector assembly as claimed in claim 9, wherein the mating face defines a plurality of recesses corresponding to the passageways, respectively, to receive the solder tails of the corresponding contacts.

11. The electrical connector assembly as claimed in claim 9, wherein a pair of protrusions are formed at two opposite longitudinal ends of on the mating face in said vertical direction with a predetermined distance.

12. The electrical connector assembly as claimed in claim 11, wherein said pair of protrusions are smaller than the mating port in said lateral direction.

13. The electrical connector assembly as claimed in claim 12, further including a printed circuit board defining an undersurface on which the housing is mounted with the solder tails soldered.

14. The electrical connector assembly as claimed in claim 13, wherein said printed circuit board defines an elongated opening extending therethrough in the vertical direction and essentially aligned with the mating face to expose the corresponding passageways thereunder.

15. The electrical connector assembly as claimed in claim 14, wherein said elongated opening is smaller than the mating port in said lateral direction while larger than the pair of protrusions in said lateral direction.

16. The electrical connector assembly as claimed in claim 15, wherein said elongated opening is larger than a dimension defined by said pair of protrusions along said longitudinal direction.

17. The electrical connector assembly as claimed in claim 16, wherein said pair of protrusions are intimately received in said elongated opening in both longitudinal direction and said lateral direction.

18. The electrical connector assembly as claimed in claim 17, wherein said pair of protrusions does not extend beyond an upper surface of the printed circuit boarding said vertical direction so as to be essentially snugly received in the elongated opening in said vertical direction.
